(19) United States
(12) Patent Application Publication
(10) Pub. No.: US 2003/0232309 A1
(43) Pub. Date: Dec. 18, 2003

(54) Bone implant

(76) Inventor: Wolfgang Dinkelacker, Sindelfingen (DE)

Correspondence Address: KUDIRKA & JOBSE, LLP, ONE STATE STREET, SUITE 1510, BOSTON, MA, 02109, US

(21) Appl. No.: 10/460,564

(22) Filed: Jun. 12, 2003

(30) Foreign Application Priority Data
Jun. 12, 2002 (DE) DE 202 09 170.8

(51) Int. Cl. A61C 8/00

(52) U.S. Cl. 433/173; 433/201.1

(57) ABSTRACT

A bone implant, in particular a dental implant, has an implant body which is joined to an abutment body. A metal layer is arranged on the surface of the implant body or the abutment body. The metal layer extends over at least a portion of the contact area between the implant body and the abutment body and comprises a lower hardness than the abutment body and/or the implant body in the contact area. The metal layer provides an intimate, jointless and lasting connection between the implant body and the abutment body.

### FIELD OF THE INVENTION

This invention relates to a bone implant, in particular a dental implant, comprising an implant body and an abutment body and a contact area between the implant body and the abutment body in which the shape of the implant body and the abutment body are adapted to one another.

### BACKGROUND OF THE INVENTION

Known enossal dental implants consist of an implant body, which is inserted into the bone and on which is placed an abutment body after conclusion of the healing phase to serve as a carrier for a dental prosthesis such as a crown. The implant body has an axial threaded bore to accommodate a screw bolt for fastening the one abutment body. The implant body may be shaped so that it is adapted to the shape of the bone surrounding it. To this end, the head of the implant body has a two-sided taper which is formed by bevels running on both sides of the threaded bore and across the row of teeth. Due to the shape of the implant, an adaptation to the differences in level between the buccal levels and the lingual levels and the approximate height of the bone is achieved, simulating a natural upper edge of the jawbone. Such a dental implant is disclosed in European Patent 0 868 889.

The abutment body of implants is to be adapted to the shape of the implant body in the area of contact therewith. Even with extremely accurate design of this adaptation, there may be a gap between the implant body and the abutment body. Bacteria may become embedded in the gaps and form lesions of infection and inflammation. The same thing also is true of any type of bone implant in multiple parts, the parts being joined before or after insertion into the bone.

For dental implants it is known to insert between the implant body and the abutment body a seal ring which consists of silicon or another plastic material (DE-A 4405797 and DE-A 19815719). Such arrangement includes the danger that during the time the material of the seal ring will be impacted by liquids collecting in the mouth of the patient so that a replacement of the seal ring is required. For improving this situation it is known to use a gold disc as seal ring (DE-A 19647490). Furthermore, it is known to provide a composed dental implant of which one part consists of glass and another one of metal. Between these parts a binding layer of glass is arranged which connects both parts with each other (DE-A 4131212). During the use of such implant pressure load may result in small deformations of the implant parts by which flaws or cracks may arise in the binding layer.

### SUMMARY OF THE INVENTION

The object of this invention is to counteract these disadvantages and to design multi-part bone implants in such a way as to permanently prevent infections and inflammations emanating from the implant in the bone tissue surrounding the implant.

The bone implant according to this invention, as defined in the claims, having an implant body and an abutment body and a contact area between both in which the shape of the implant body and the abutment body are adapted mutually. On the surface of the implant body and/or the abutment body a coating by a metal layer is provided in at least a portion of the contact area between the implant body and the abutment body. The metal layer comprises a lower hardness than the abutment body and/or the implant body in the contact area. It provides an intimate, joint-free and lasting connection between the implant body and the abutment body. The invention is particularly suited for implants having an implant body with a profile which is adapted to the form of the bone surrounding the inserted implant.

The metal layer is preferably produced by sputtering or by galvanic deposition. The material of which the metal layer consists preferably of titanium, a titanium alloy or gold.

A further object of this invention is a method, as defined in the claims, for producing a bone implant.

### BRIEF DESCRIPTION OF THE DRAWINGS

An exemplary embodiment of this invention is described below on the basis of drawings, which show:

FIG. 1 is a dental implant according to this invention in a sectional diagram with a sectional line running along the longitudinal axis of the implant;

FIG. 2 is another sectional diagram of the dental implant from FIG. 1 with a sectional line offset by 90 degrees with respect to FIG. 1;

FIG. 3 is a top view of an implant body such as that used in the dental implant of FIGS. 1 and 2;

FIG. 4 is an enlarged sectional diagram of the contact area between the implant body 1 and the abutment body 3; and

FIG. 5 is a sectional diagram of an implant body of another embodiment of a dental implant according to this invention.

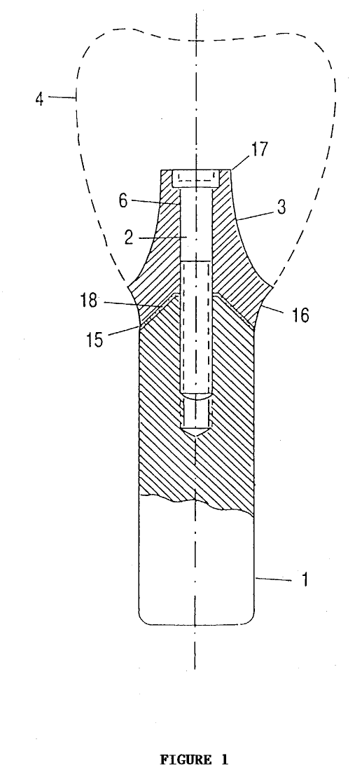

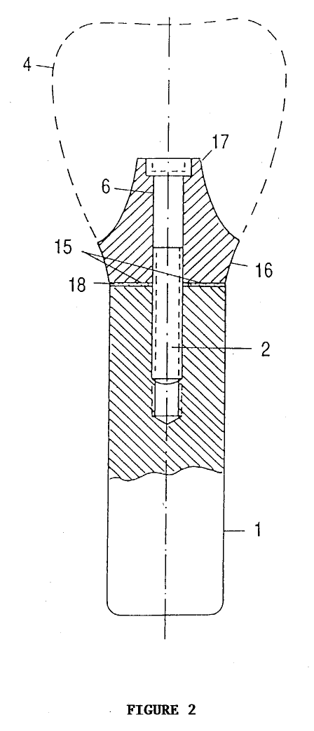

### DETAILED DESCRIPTION

The exemplary embodiment illustrated here shows a dental implant having an implant body 1, which is attached by a screw 2 to an abutment body 3 that functions as a carrier for a dental prosthesis 4. The abutment body 3 has a central bore 6 through which the screw 2 is guided to engage in a central threaded borehole of the implant body 1.

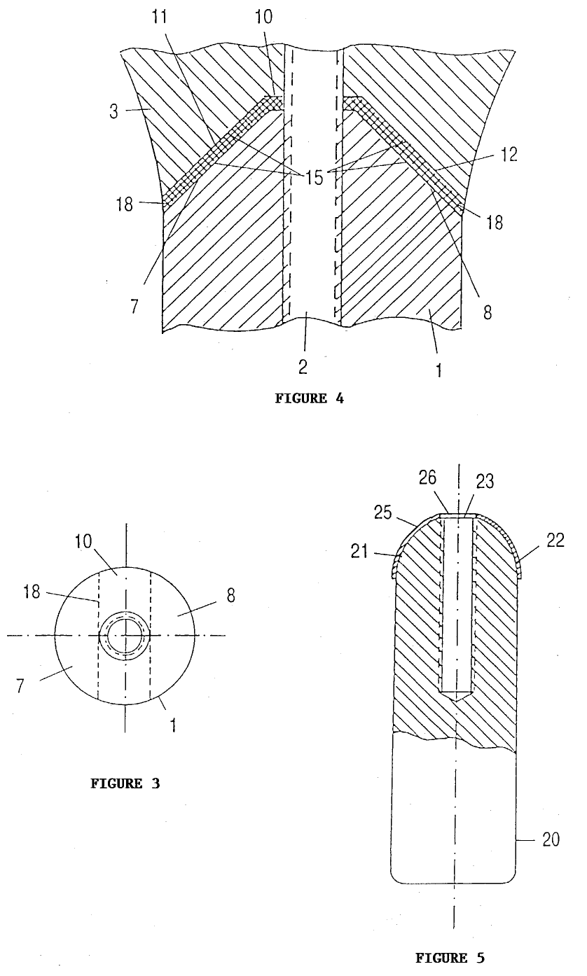

The implant body 1 is designed as a cylinder whose end facing the abutment body 2 has bevels 7, 8 (FIG. 4). The bevels 7, 8 develop out of a head face 10, which forms the end of the implant body 1 facing the abutment body 3. They are arranged on opposing sides of the implant body 1 with respect to the longitudinal axis of the implant. The abutment body 3 is adapted to the shape of the implant body 1 in a complimentary fashion.

For this purpose the abutment body 3 is hollow and has inclined surfaces 11, 12 in its hollow area corresponding to the bevels 7, 8 on the head of the implant body 1. A base surface, which is adapted to the head surface 10 of the implant body 1, is situated between the surfaces 11 and 12. Starting from its lower end, the peripheral profile of the abutment body 3 increases at first in a peripheral line 16, which has a slight curvature, and then falls in a curve down to a diameter 17, which is dimensioned according to the dental prosthesis to be applied, such as a crown 4.

The implant body 1 and the abutment body 3 of the exemplary embodiment shown here are designed to be rotationally symmetrical. An implant of this type is disclosed in European Patent EP-A 0 868 889. In deviation from that design, the implant or parts thereof in the present case may have a non-round shape. Thus, the abutment body 3 may have an elliptical cross section, as illustrated in European Patent EP-A 1 205 158. In such embodiments, the contact area corresponds to the shape of the implant body 1 and the abutment body 3.

The implant body 1 and the abutment body 3 are made of a material, which is compatible with the bone substance of the human body and also has the required hardness. This may be a gold alloy, titanium or a titanium alloy, a ceramic or a ceramic compound such as a gold ceramic.

The contact area 15 between the implant body 1 and the abutment body 3 is produced largely without joints or gaps. Depending on the production method used, however, gaps in the order of a few micrometers may nevertheless occur. Bacteria may become embedded in the gaps, thereby forming lesions for infections and inflammations. This is prevented by a seal, which is applied in contact area 15 between the implant body 1 and the abutment body 3.

The seal preferably consists of a thin layer 18 of a material, which is produced by surface treatment of at least one of the implant parts and extends over at least one part of the contact area 15. In the exemplary embodiment shown here, the covering layer 18 covers the entire contact area 15 except for the borehole for accommodating the screw 2 (FIGS. 3 and 4). In deviation from that, the sealing layer 18 may be designed so that it is arranged in a zone of the contact area 15 extending in the peripheral direction. The covering layer may thus be limited to a peripheral part of the contact area 15, which extends in a ring around the center of the implant body 1 and the abutment body 3.

The thickness of the sealing layer 18 may be between 0.5 micrometer and 1 millimeter, preferably in the range of 10 to 300 micrometers. The sealing 18 may consist of a titanium layer that is applied to the surface parts 11 and 12 in the contact area 15 of the abutment body 3 and/or to the corresponding mating surfaces 7, 8, 10 of the implant body 1 by sputtering. Instead of titanium, other metals may also be used to produce the layer 18 by employing the sputtering technique. The layer may also be applied by vapor deposition or by the galvanic technique. Thus, a layer of gold or some other metal may be applied galvanically to at least a portion of the surface of implant body 1 and/or abutment body 3.

As an alternative to the embodiment described above, the sealing layer 18 may also be made of a film which is inserted into the contact area 15 between the implant body 1 and the abutment body 3 and extends over at least a ring-shaped portion of the contact area 18 as described above. The film has a hole in the area of the screw passage. Its thickness is less than 500 micrometers, preferably between 10 and 300 micrometers. It may be a titanium film or gold leaf. In addition, the sealing layer may also be produced by applying a silicon coating, which is produced before bonding the implant parts to the contact area.

For implants with a rounded or curved contact area, preshaped films may be used as sealing layers. FIG. 5 shows an implant body on which the bevels are designed as areas 21, 22 having a convex curvature arranged on opposite sides of the implant body 20 with respect to the longitudinal axis of the implant. An abutment body (not shown) is designed to be complementary to the areas 21, 22 and a head surface 23, as described for the abutment body 3. A film 25 is preshaped according to the shape of the head of implant body 20. It has a central passage 26 for the faceting screw (not shown). The film is applied in this form between the implant body 20 and the abutment body before the two parts are pressed together by the fastening screw. This prevents the development of folds in the film on insertion of the abutment body.

Although this invention has been described on the basis of a preferred embodiment, modifications and other embodiments may also be implemented without going beyond the scope of this invention as defined by the claims. This invention can thus be used with implants consisting of more than two parts to protect their contact areas from the development of bacterial lesions.

This invention is not limited to dental implants. It can be used with all bone implants which consist of two or more parts that require jointless or gapless connection.

What is claimed is:

1. A bone implant, in particular a dental implant, having an implant body and an abutment body and having a contact area between the implant body and the abutment body in which the shape of the implant body and the abutment body are adapted mutually and in which a sealing means is arranged, characterized by a metal layer arranged as a coating on the surface of the implant body or the abutment body in the contact area, where the metal layer comprises a lower hardness than the abutment body and/or the implant body in the contact area.

2. The implant according to claim 1, wherein the implant body and the abutment body each comprising a metal layer on its surface in the contact area.

3. The implant according to claim 1, wherein the metal layer is arranged in a zone of the contact area which extends in its peripheral direction.

4. The implant according to claim 1, wherein the metal layer comprises a layer produced by sputtering.

5. The implant according to claim 4, wherein the metal layer comprises a sputtered titanium or titanium alloy layer.

6. The implant according to claim 4, wherein the metal layer comprises a sputtered gold layer.

7. The implant according to claim 1, wherein the metal layer comprises a layer produced by galvanic deposition.

8. The implant according to claim 7, wherein the metal layer comprises a galvanic deposited gold layer.

9. The implant according to claim 1, wherein the metal layer comprises a layer produced by vapor deposition.

10. The implant according to claims 1, wherein the metal layer has a thickness between 0.5 micrometer and 1 millimeter.

11. The implant according to claim 1, characterized in that the implant body and the abutment body comprise a rotationally symmetrical cross section in the contact area, and the metal layer covers at least one ring-shaped zone of the contact area extending parallel to its circumference.

12. The implant according to claim 1, characterized in that the implant body and the abutment body comprise a non-round cross section in the contact area, and the metal layer covers at least one zone of the contact area extending in parallel to its peripheral line.

13. The implant according to claim 1, wherein the implant is a dental implant.

14. A method of producing a bone implant having an implant body and an abutment body and having a contact area between the implant body and the abutment body in which the shape of the implant body and the abutment body are adapted mutually and in which a sealing means is arranged, characterized in that a metal layer is applied to the surface of the implant body or the abutment body in the contact area, where the metal layer is made of a metal which comprises a lower hardness than the abutment body and/or the implant body in the contact area.

15. The method according to claim 14, comprising the step of applying a metal layer to the surface of each of both the abutment body and the implant body in the contact area.

16. The method according to claim 14, comprising the step of applying the metal layer in a zone of the contact area which extends in peripheral direction in form of a ring.

17. The method according to claim 14, wherein the metal layer is made by sputtering.

18. The method according to claim 17, wherein the metal layer is made by sputtering titanium or a titanium alloy.

19. The method according to claim 14, wherein the metal layer is made by galvanic deposition.

20. The method according to claim 19, wherein the metal layer is made by galvanic deposition of gold.

21. The method according to claim 14, wherein the metal layer is made by vapor deposition.

22. The method according to claim 14, wherein the metal layer comprises a thickness between 0.5 micrometer and one millimeter.

23. The method according to claim 22, wherein the metal layer comprises a thickness in the range between 10 and 300 micrometer.

24. The method according to claim 14, characterized in that the implant body and the abutment body comprising a rotationally symmetrical cross section in the contact area, and the method comprising the step of applying the metal layer to at least one ring-shaped zone of the contact area extending parallel to its circumference.

25. The method according to claim 14, characterized in that the implant body and the abutment body comprising a non-circular cross section in the contact area, and the method comprising the step of applying the metal layer to at least one ring-shaped zone of the contact area extending parallel to its circumference.

26. The method according to claim 14, wherein the implant is a dental implant.
